(19) United States
(12) Patent Application Publication
(10) Pub. No.: US 2003/0044751 A1
(43) Pub. Date: Mar. 6, 2003

(54) Radiographic bitewing

(76) Inventors: Richard J. Deslauriers, Woodbury, CT (US); Robert T. Potash, South Windsor, CT (US); Leonard Infranco, Lawrenceville, NJ (US); Stephanie Bonin, East Hartford, CT (US)

Correspondence Address: Richard J, Deslauriers, M.D., 50 Altair Avenue, Plymouth, CT, 06782, US

(21) Appl. No.: 09/990,956

(22) Filed: Nov. 16, 2001

Related U.S. Application Data
(63) Continuation-in-part of application No. 09/946,697, filed on Sep. 4, 2001.

(51) Int. Cl. A61C 19/04

(52) U.S. Cl. 433/72; 378/168

(57) ABSTRACT

A radiographic bitewing for determining the depth for a dental implant comprising a patient bite portion and an extension portion, wherein said bite portion is adapted for placement between a patient's upper row of teeth and lower row of teeth, and wherein said extension portion is aligned in a substantially perpendicular position relative to said bite portion and comprises at least one radio-opaque calibration template, wherein said calibration template comprises a first vertical bar having a first dimension, a second vertical bar having a second dimension, a third vertical bar having a third dimension, and a fourth vertical bar having a fourth dimension.

### CROSS-REFERENCE TO RELATED APPLICATIONS

This Application is a Continuation in Part of U.S. patent application Ser. No. 09/946,697 filed on Sep. 4, 2001, the entire disclosure of which is incorporated herein by reference.

### BACKGROUND OF THE INVENTION

1. Field of the Invention

This invention relates to the field of radiographic x-ray devices for use in the determination of the insertion depth for dental implants.

2. Description of the Related Art

Individuals may require a dental implant due to the removal of an existing tooth or a missing tooth. The implanting of a prosthetic tooth may require the implantologist to secure a post or abutment to the patient's jaw, and where a crown or synthetic tooth may then be secured to the exposed portion of the post. In this process of securing the post to the patient's jaw, the dentist may be required to take x-rays of the patient's mouth to determine the location for the insertion of the replacement tooth. Specifically, the x-ray films may provide the doctor with a depiction of the occlusal surfaces of the patient's teeth, and in particular, the location of the dental nerve and sinuses located within the patient's jaw.

The determination of the exact location of the dental nerve and sinuses is important, as the doctor is required to insert the post into the patient's jaw, such that the implant may be placed deep enough into the jaw to provide adequate lateral strength for the implant. However, the doctor must use care, so as not to cause any damage to the nerves or sinuses in a maxilla and/or mandible, during both boring the implant site as well as the insertion of the implant. In this process of determining the location of the dental nerve, the doctor may take a series of panoramic x-rays of the patient, and wherefrom the doctor may estimate the location of the nerve in the jaw relative to the occlusal surfaces of the patient's teeth, and with respect to the curvature of the patient's jaw.

However, there is a significant drawback in the determination of the exact depth and location of the nerve and sinuses when based upon panoramic x-ray films. The reason for the difficulty is that the taking of the panoramic x-ray, which provides for one x-ray film depicting the entire row of teeth, distorts the scale and size of the patient's jaw on the x-ray film. This distortion of the scale increases the difficulty in precisely determining the depth of the nerve quickly, as the doctor may be required to make approximations of the depth by taking a series of x-rays, while progressively boring a hole to a depth that approaches the nerve without causing any damage or trauma to the region.

### BRIEF SUMMARY OF THE INVENTION

Therefore a need has arisen for a radiographic bitewing that overcomes these and other shortcomings of the related art. A technical advantage of the present invention is to provide a device for determining the distance from a tooth's occlusal surface to a nerve or sinus in a patient's jaw. It is another technical advantage of the present invention to provide a device for determining an actual distance from an occlusal tooth surface to a sinus or nerve through direct comparison of a distorted image displayed on a x-ray film, without the need to determine conversion ratios.

According to a preferred embodiment of the present invention, a radiographic bitewing that may comprise a patient bite portion and an extension portion is described, wherein said bite portion may be adapted for placement between a patient's upper row of teeth and lower row of teeth, and wherein said extension portion may be aligned in a substantially perpendicular position relative to said bite portion and may comprises at least one radio-opaque calibration template. In this embodiment, calibration template may comprise a first vertical bar having a first dimension, a second vertical bar having a second dimension, a third vertical bar having a third dimension, and a fourth vertical bar having a fourth dimension.

This invention further discloses a method of determining the size and location of a dental implant utilizing said bitewing through direct comparison that may comprise the steps of, first, placing said bite portion between a upper row of teeth and a lower row of teeth in a patient's mouth having extension portion on the outside of said lower teeth and said upper teeth, and then taking a x-ray photograph with said bitewing between said teeth, and wherein said radio-opaque template may be imprinted onto a x-ray film, wherein said imprint may provide a means to have reference points measured and compared to other distances which may be sought for the determination of an implant depth.

Other objects, features, and advantages will be apparent to persons of ordinary skill in the art in view of the following detailed description of the invention and the accompanying drawings.

### BRIEF DESCRIPTION OF THE SEVERAL VIEWS

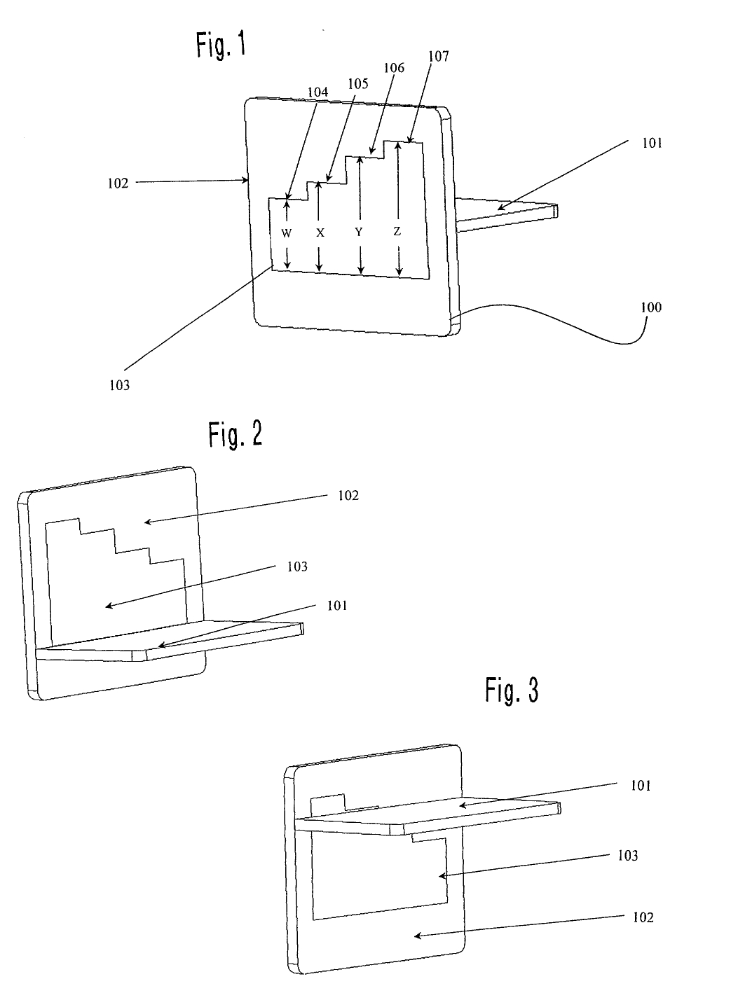

FIG. 1 depicts a front view of the device according to the preferred embodiments of the present invention.

FIG. 2 depicts a rear view of the device according to the preferred embodiments of the present invention.

FIG. 3 depicts a rear view of the device according to the preferred embodiments of the present invention.

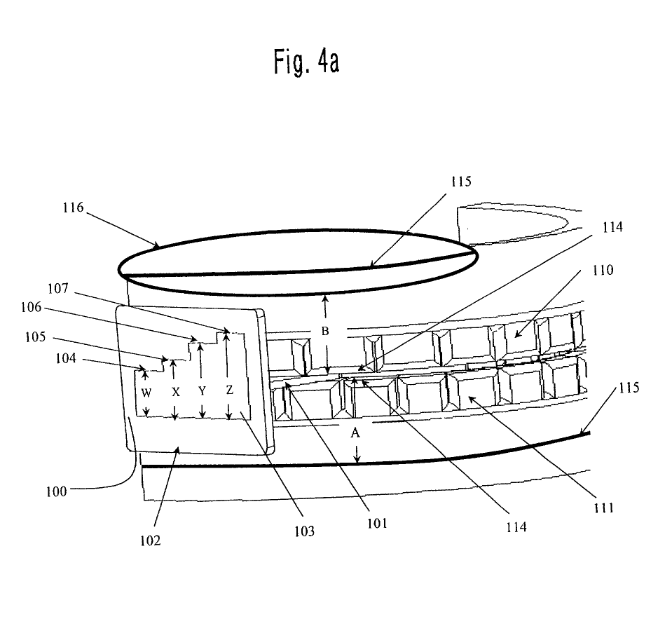

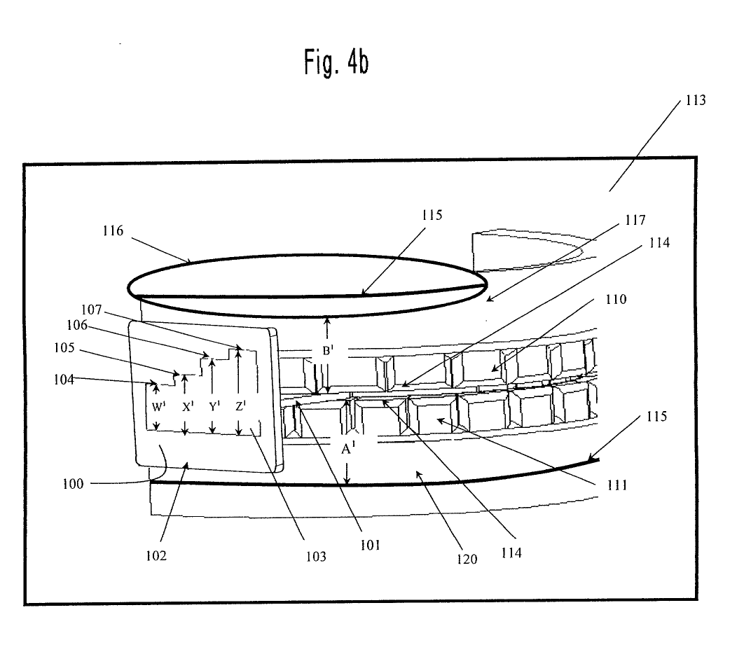

FIG. 4a depicts the device according to the preferred method of use of the present invention.

FIG. 4b depicts the device according to the preferred method of use of the according to the present invention.

### DETAILED DESCRIPTION OF THE INVENTION

Preferred embodiments of the present invention and their advantages may be understood by referring to FIGS. 1-4, like numerals being used for like corresponding parts in the various drawings.

FIG. 1 depicts a radiographic bitewing 100 according to the preferred embodiments of the present invention. Bitewing 100 may comprise a patient bite portion 101 and an extension portion 102. Bite portion 101 may comprise a flat piece of material adapted for placement between a patient's upper row of teeth and lower row of teeth, and of a of minimum thickness, such that the jaw of said patient is in a substantially closed position after the placement of bite portion 101.

Extension portion 102 may be aligned in a substantially perpendicular position relative to bite portion 101. Extension portion 102 may comprise a substantially flat piece of material. Further, extension portion may comprise at least one radio-opaque calibration template 103, wherein calibration template 103 may comprise at least one radio-opaque vertical bar having a known dimension. Additionally, calibration template 103 may be manufactured into extension portion 102. Alternatively, calibration template 103 may be manufactured and placed on the outer surface of extension portion 102.

According to the preferred embodiments of this invention, calibration template 103 may comprises a first vertical bar 104 having a first dimension W, a second vertical bar 105 having a second dimension X, a third vertical bar 106 having a third dimension Y, and a fourth vertical bar 107 having a fourth dimension Z. For example, in an embodiment of calibration template 103, first dimension W may have a height of about 8 mm, second dimension X may have a height of about 10 mm, third dimension Y may have a height of about 13 mm, and fourth dimension Z may have a height Z of about 16 mm.

In other embodiment of the present invention bite portion 101 may be in varying positions relative to extension portion 102. For example, extension portion 102 may extend in an upward direction relative to said bite portion 101, as shown in FIG. 2, or in the alternative, extension portion 102 may extend in a downward direction relative to said bite portion 101, as shown in FIG. 3. Nevertheless, it will be understood by those of ordinary skill in the art that these positions extension portion 102 relative to bite portion 101 are merely examples.

In still another embodiment of the present invention, extension portion 102 may extend both in an upper direction and a lower direction, wherein the embodiments shown in FIGS. 1a-1b maybe combined so as to provide for a bitewing 100 having an extension portion 102 comprising an upper portion having a first calibration template 103 and a lower portion that may comprise a second calibration template 103 that may comprise at least one radio-opaque vertical bar having a known dimension. (Not Shown).

FIGS. 4a-4b depict a preferred method of determining the size and location of a dental implant, through direct comparison without the need for the determination of conversion ratios, pursuant to taking a x-ray photograph of a patient's jaw holding bitewing 100 having radio-opaque calibration template 103, wherein calibration template 103 comprises a first vertical bar 104 having a first dimension W, a second vertical bar 105 having a second dimension X, a third vertical bar 106 having a third dimension Y, and a fourth vertical bar 107 having a fourth dimension Z. This method comprises the steps placing said bite portion between a upper row of teeth 110 and a lower row of teeth 111 in a patient's mouth, wherein extension portion 102 may be positioned on the outside of teeth 110 and teeth 111. Next, a x-ray photograph may be taken with said bitewing between teeth 110 and teeth 111, and such that radio-opaque template is imprinted onto a x-ray film 113, wherein said imprint provides a means to have reference points measured. After, the x-ray photograph is taken bitewing 100 may be removed from said patient's mouth and discarded.

An actual distance A from an occlusal surface 114 to a nerve 115 or an actual distance B to sinus 116 of a subject's maxilla 117 is determined through the direct comparison of the distorted dimensions, W¹, X¹, Y¹, and Z¹ of calibration template 103 in said x-ray film 113 to the distorted distance A¹ from occlusal surface 114 to nerve 115 or the distorted distance B¹ to sinus 116 shown in x-ray film 113, wherein the actual dimensions of calibration template 103 are known. In this preferred method, the distorted distance A¹ is determined and then compared to the dimensions W¹, X¹, Y¹, and Z¹. One of distances W¹, X¹, Y¹, and Z¹ may provide for a substantially similar distance to A¹, such that A¹ may be about equal to X¹, and wherefrom distance A may then be about equal to distance X, which is know, and thus provide for actual distance A without the need for any conversion ratios to be required for the determination of actual distance A from a distorted distance A¹. The same method of comparison may then be used for the determination of distance B from B¹.

An actual distance from an occlusal surface 114 to a nerve 115 of a subject's mandible 120, utilizing the above described method, is determined through the direct comparison of the distorted dimension of said calibration template 103 in said x-ray film 113 to the distorted distance from occlusal surface 114 to nerve 115 in x-ray film 113, wherein the actual dimensions of calibration template 103 are known.

According to other embodiments of the present method of determining the distance in a x-ray photograph, a conversion ratio may be determined for the distance of nerves 115 and sinuses 116 in a subject's maxilla 117 from the patient's tooth's occlusal surface 114, wherein a conversion ratio is determined for the distance of nerves in a subject's mandible 120 from occlusal surface 114. For example, where there is an original length W of calibration template 103 is about 8 mm and the x-ray film 113 distance W₁ is about 6 mm, then said conversion ratio may be W/W₁, or 8/6, then distance A may be determined by multiplying A¹ by 8/6. (e.g. x-ray film measurement multiplied by 1.333). Therefore, if x-ray film distance A¹ from occlusal surface 114 to nerve 115 is about 7 mm, then actual distance A from occlusal surface 114 to nerve 115 may be about 9.331 mm.

While the invention has been described in connection with preferred embodiments, it will be understood by those of ordinary skill in the art that other variations and modifications of the preferred embodiments described above may be made without departing from the scope of the invention. Other embodiments will be apparent to those of ordinary skill in art from a consideration of the specification or practice of the invention disclosed herein.

What is claimed is:

1. A radiographic bitewing comprising:
a patient bite portion wherein said bite portion is adapted for placement between a patient's upper row of teeth and lower row of teeth; and
an extension portion comprising at least one radio-opaque calibration template.

2. The device of claim 1, wherein said extension portion is aligned in a substantially perpendicular position relative to said bite portion.

3. The device of claim 1, wherein said calibration template comprises a material selected from one of the group consisting of lead foil, stainless steel, or barium sulfate.

4. The device of claim 1, wherein said calibration template comprises at least one radio-opaque vertical bar having a known dimension

5. The device of claim 4, wherein said calibration template comprises a first vertical bar having a first dimension, a second vertical bar having a second dimension, a third vertical bar having a third dimension, and a fourth vertical bar having a fourth dimension.

6. The device of claim 5, wherein said first dimension provides for a height of about 8 mm.

7. The device of claim 5, wherein said second dimension provides for a height of about 10 mm.

8. The device of claim 5, wherein said third dimension provides for a height of about 13 mm.

9. The device of claim 5, wherein said fourth dimension provides for a height of about 16 mm.

10. The device of claim 1, wherein said extension portion extends in an upward direction relative to said bite portion.

11. The device of claim 1, wherein said extension portions extends in a downward direction relative to said bite portion.

12. A radiographic bitewing comprising:
a patient bite portion, wherein said bite portion is adapted for placement between a patient's upper row of teeth and lower row of teeth; and
an extension portion comprising at least one radio-opaque calibration template, wherein said extension portion is aligned in a substantially perpendicular position relative to said bite portion, and wherein said calibration template comprises a first vertical bar having a first dimension, a second vertical bar having a second dimension, a third vertical bar having a third dimension, and a fourth vertical bar having a fourth dimension.

13. The device of claim 12, wherein said extension portion extends in an upward direction relative to said bite portion.

14. The device of claim 12, wherein said extension portions extends in a downward direction relative to said bite portion.

15. A method of determining the size and location of a dental implant, utilizing the device of claim 1, through direct comparison comprising the steps:
Placing said bite portion between a upper row of teeth and a lower row of teeth in a patient's mouth having extension portion on the outside of said lower teeth and said upper teeth,;
Taking a x-ray photograph with said bitewing between teeth;
Removing said bitewing from said patient's mouth and discarding said bitewing; and
Wherein said radio-opaque template is imprinted onto a x-ray film, wherein said imprint provides a means to have reference points measured.

16. The method of claim 15, wherein an actual distance from a tooth's occlusal surface to a nerve or sinus of a subject's maxilla is determined through the direct comparison of the distorted dimension of said calibration template in said x-ray film to the distorted distance from said occlusal surface to said nerve or sinus in said x-ray film, wherein the actual dimension of calibration template is known.

17. The method of claim 15, wherein an actual distance from a tooth's occlusal surface to a nerve of a subject's mandible is determined through the direct comparison of the distorted dimensions of said calibration template in said x-ray film to the distorted distance from said occlusal surface to said nerve in said x-ray film, wherein the actual dimension of calibration template is known.

18. The method of claim 15, wherein a conversion ratio is determined for the distance of nerves and sinuses in a subject's maxilla from the patient's tooth's occlusal surface.

19. The method of claim 15, wherein a conversion ratio is determined for the distance of nerves in a subject's mandible from the patient's tooth's occlusal surface.
